(19) United States
(12) Patent Application Publication
(10) Pub. No.: US 2009/0185699 A1
(43) Pub. Date: Jul. 23, 2009

(54) BONE CONDUCTION HEADSET

(76) Inventor: Sung-Ho Kim, Seoul (KR)

Correspondence Address: John W. Renner;RENNER, OTTO, BOISSELLE & SKLAR, 1621 Euclid Avenue, 19th Floor, Cleveland, OH, 44115, US

(21) Appl. No.: 12/301,084

(22) PCT Filed: May 17, 2007
(86) PCT No.: PCT/KR07/02419

§ 371 Date: Nov. 17, 2008

(30) Foreign Application Priority Data
May 17, 2006 (KR) 10-2006-0044159
Jul. 28, 2006 (KR) 10-2006-0071157

(51) Int. Cl. H04R 25/00

(52) U.S. Cl. 381/151

(57) ABSTRACT

This invention is about bone conduction headset, method of bone conduction method and eardrum, it has hearing-aid function, provide bone conduction headset which is folded compactly using first and second extension part, first and second hinge part and hinge axis, also provide bone conduction headset which is received and output the signal not only wired but also wireless method.

### TECHNICAL FIELD

This Invention is about the Bone Conduction Headset that is assist to hear the sounds both way not only through the bone but also through the ear drum. This invented Bone Conduction Headset is supplied movable articulated joint that is make suitable for any different type of users ears and make easy to carry by fold the headset. Moreover, this invention make possible to wireless communication.

### BACKGROUND ART

Recently, There are developing the various kind of bone conduction headset.

Existed bone conduction headset consist with speaker elements where is placed to headband and one of them is connected with a microphone. And existed bone conduction headset constructed to hear the sound through the bone only by hitting the skull with vibration.

However, its uncomfortable when wearing the headset because they are weighted, big speaker size and bulky. Also, this kind of headset is hard to storage as bulky with a headband and rage size of speakers earpiece. And user can't hear the sound by using ear drum as rage size of speakers must be closed to the skull.

And now a days, multi-function headphone are available that is can use as a hands free function as well as good quality headset by supply of Mobile Phone that is supported function of MP3 player and Portable Audio player. Moreover, There are developing the Wireless Headset to connect with mobile phone or portable audio player.

### DISCLOSURE OF INVENTION

### Technical Problem

This invention is originated to solve existed problem and that is about the Bone Conduction Headset that is assist to hear the sounds both way not only through the bone but also through the ear drum. This invention supply movable articulated joint that is make suitable for any different type of user's ears and make easy to carry by fold the headset. Moreover, this invention make possible to wireless communication.

### Technical Solution

This invention provide bone conduction headset comprising head band part(10) which is weared or put in the head consisted of (a) the center part(11) which includes each first hinge(22) in both side, and (b) first extension part(21) which is conjoined to the first hinge(22) in one side, and (c) second extension part(23) which is conjoined in one side to the second hinge(24) included the other side of the first extension part(21), conjoined in the other side to the hinge axis(25); a pair of bone conduction speaker part(30) which is included of bone conduction vibrator and is conjoined to hinge axis(25) of second extension part(23) as above-mentioned movably; microphone(40) which is included to widen bone conduction speaker part(30) to head band part(l0) as above-mentioned or is formed with bone conduction speaker part(30); and the first hinge(22) is comprised by coupling inclined section(12a) which is inclined in upward direction from the outside to inside on both side of center part(l 1) and inclined section(12) on one part of the first extension part(21) which is surface-connected with the inclined section(12a), and the second hinge(24) is comprised by coupling the other part of the first extension part(21) and the one part of the second extension part(23).

It is desirable that the first hinge(22) or second hinge(24) include means for controlling the rotating angle of the first extension part(21) or the second extension part(23), and the controlling means is placed on the one side of second hinge(24) or one side of inclined section(12) of first hinge(22) as above-mentioned, the controlling means include stumbled part(26) which is formed with several stumbling part(27) on the surroundings, and the groove(28) which is placed on another side of inclined section(12a) of first hinge(22) or another side of second hinge(24), inserted by stumbled part(26), the groove (28) includes elastic stopper(29) which is caught of stumbling part(27) as above-mentioned by moving first extension part(21) or second extension part(23).

Furthermore, short-distance wireless telecommunication module(50) which is transmitted and received with other communication devices and amplification mean can be placed on the first extension part(21) or second extension part(23) or head band part(l0), connected with speaker part(30) and microphone(40).

Additionally, it is easy to move the bone conduction speaker part more freely by conjoining a pair of connection block(31) between the hinge axis(25) of each bone conduction speaker part(30) and hinge axis(25) of one side of second extension part(23), it is movable from second extension part(23) to bone conduction speaker part(30) with several articulations.

### ADVANTAGEOUS EFFECTS

As mentioned as above, this invented Bone Conduction Headset has a movable articulated joint that is continued to where the place of user's skull and ears, and it make available to hear the sound in both way, through the ear and through the method of bone conduction.

Therefore, this invented bone conduction headset is an adequate to use for more people class because of the general public also can hear the sound by ear drum to compare with existed bone conduction headset is used to special people such as a hearing impaired people. Also, this invention is effective that make suitable to place for any different type of user's ears with Bone Conduction Speaker Part(30) is combined with extension part of Headset(20) by connection part(31) in order to movable in freely.

Also, according to this invention, foldable headset make easy to storage and carry with a couple of extension parts which has speaker parts of headset is extended from the head band part. Moreover, it has more usable effective to storage and carry by Speaker part is placed of inside of circular configuration with consist of extension part can fold a more time.

And this invention make available to use for the people who has a different type of head size and shape by extension part that consist with a stopper and stumbling block which is adjustable of movement angle is attached to movable hinge part.

And according to this invention, this headset is offerable multi-function by equip the radio wireless communication module in order to connect with other communication device and MP3 Module in order to enjoy the music without portable audio player to inside of headset.

And, according to this invention, this headset have a superior effective of feeling of wearing because of install the wireless module to extension part or head band and this make available to lose of size and weight of speaker part so that user don't need to cover the ear. Therefore, user can not only hear the sound from outside but also can listen to the music or communicate by connect with portable audio device or communication device using method of wireless.

### BRIEF DESCRIPTION OF THE DRAWINGS

FIG. 1 is a drawing of invention Bone Conduction Headset.

FIG. 2 is a example drawing of disassembled hinge which is important part of this invention.

FIG. 3 is a example sectional view of combine construction of hinge with is important part of this invention.

FIG. 4 is a example plane figure of process of fold of headset.

FIG. 5 is a example drawing of how to operate

FIG. 6 is an other example drawing of how to operate.

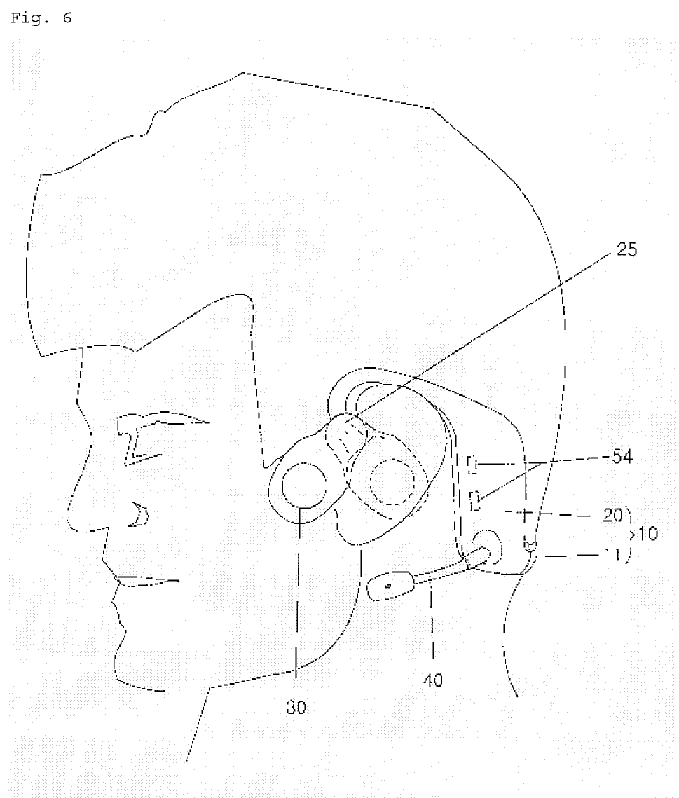

FIG. 7 is a Block diagram of circuit of another example drawing.

FIG. 8 is a Block diagram of circuit of the other example drawing.

FIG. 9 is a disassembled drawing of combine construction of speaker of example of FIG. 8.

FIG. 10 is a plane figure of process of headset fold of FIG. 8.

FIG. 11 is a drawing of operation of FIG. 8.

### BEST MODE FOR CARRYING OUT THE INVENTION

The aim, characteristic and advantage of this invention will be more obvious with below detail explanations. And, belows are the detail explanation according to the attached drawing of example.

### Example No. 1

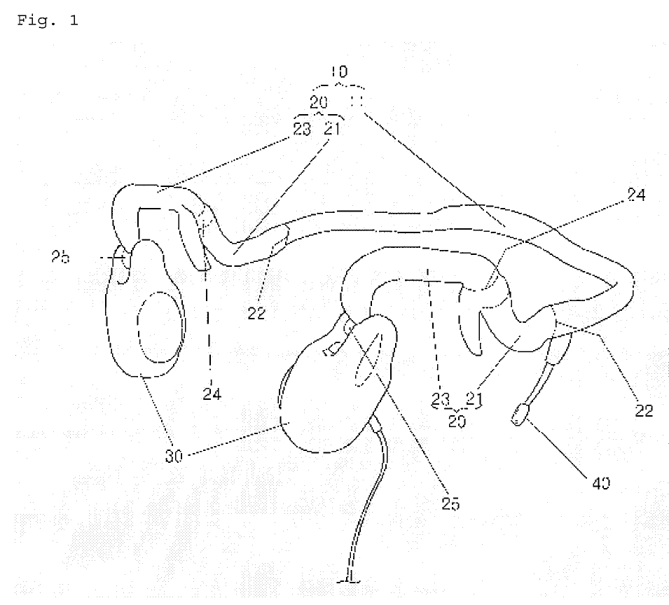

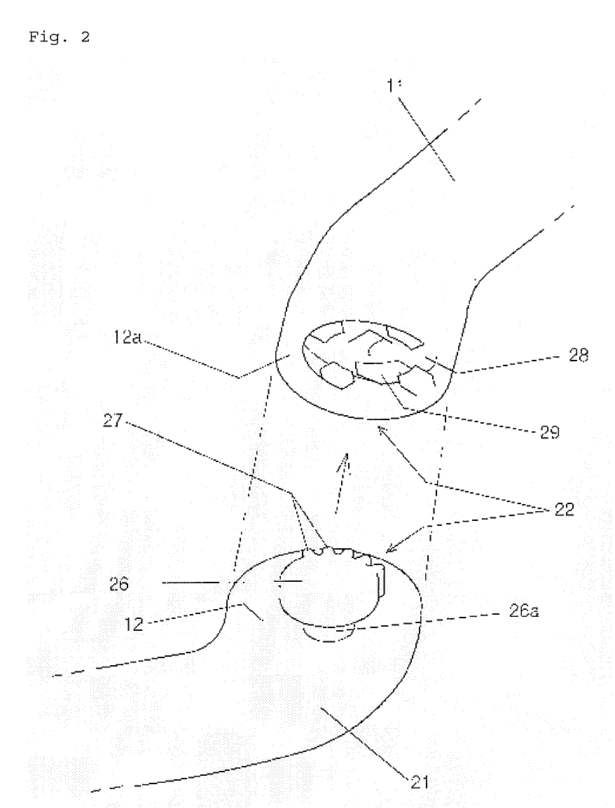

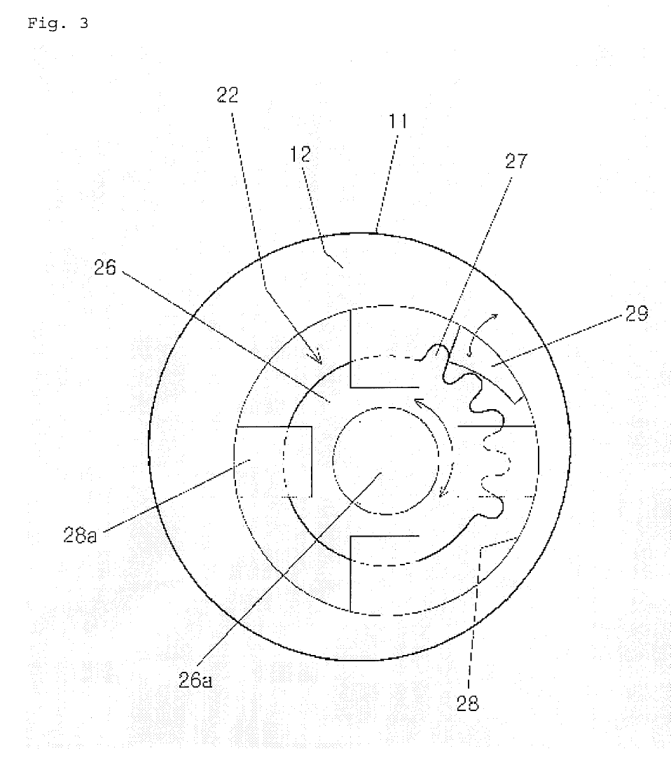

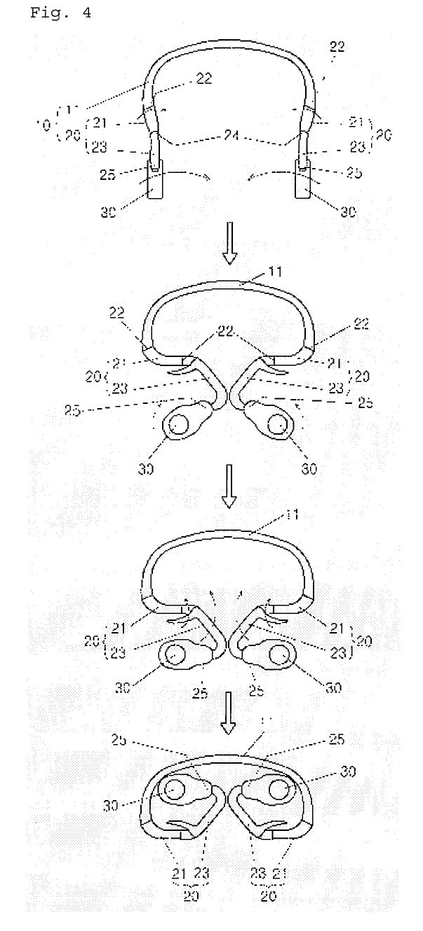

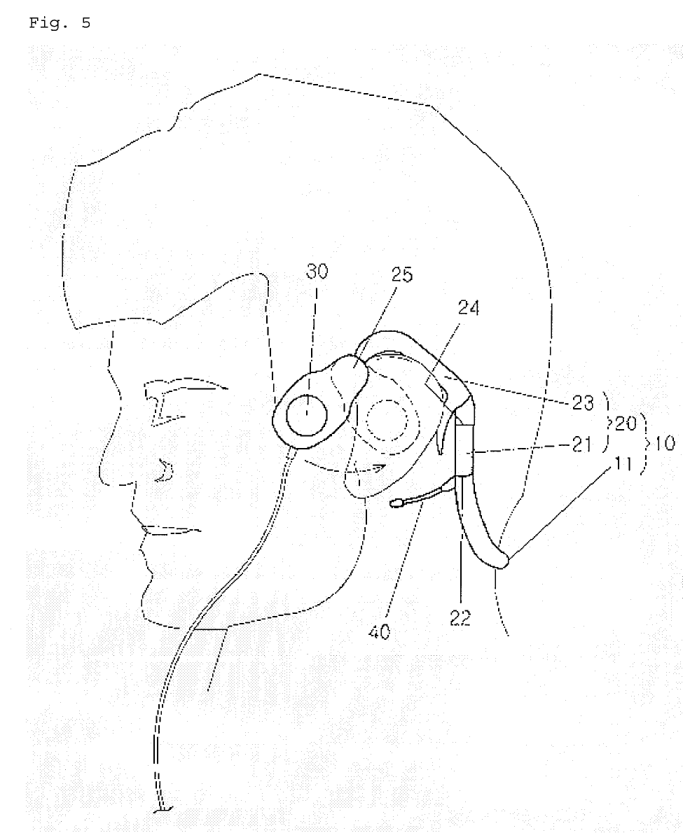

FIG. 1 is a drawing of invention Bone Conduction Headset, FIG. 2 is a example drawing of disassembled hinge which is important part of this invention, FIG. 3 is a example sectional view of combine construction of hinge with is important part of this invention, FIG. 4 is a example plane figure of process of fold of headset and FIG. 5 is a example drawing of operating.

As shown on drawing, this invented bone conduction headset is consist with a headband(l0) which is placed on top of head or around of back head, the extension parts(20) which is extended with a Head band(l0), microphone(40) which is placed to a extension part(20) and a couple of bone conduction speaker part(30) which is connected with a extension part(20) that is closed to user's head.

Head band part(l0) could be consisted to wearable not only on the tope of head with a hat or helmet, also put on the around of back head.

Here this example, exampled the Head band which is formed put around on back head. Also, this head band(l0) is a formed with circle or something like stick, and it's consist with center part(11) which has a first hinge part (22) at the both side of section and extension part(20) which is conjoined to the both side section of center part(11).

This a couple of extension part(20) is consisted with first extension part(21) and second extension part(23), and first extension part(21) is conjoined with first hinge(22) which is placed at center part(11),

and second extension part(23) is conjoined with second hinge(24) which is placed at the first extension part(21).

The first hinge(22) is conjoined with both of center part(11) and a side of each section part of first extension part(21).

At this time, each section part(12) as above-mentioned, is formed in slope to the axis of first extension part(21) and center part(11), and both section of circled center part(11) is formed to inclined part(12) which is upper inclined from the external side to internal side(to the direction of circle center).

And, first extension part(21) is formed inclination part(12a) which is connected with inclined part(12), and first extension part(21) is folded to center part(11) proximately by move of first extension part(21) with a connection of center part(11) at the first hinge(22).

Also, movable axis(26a) is formed vertically with a inclination part(12a) on the a side of inclination part(12a) of first extension part(21), and this stumbled part(26) which is formed of a number of stumbling part(27) horizontally with inclination part(12a) at upper side of movable axis(26), is projected in all directions.

Also, groove(28) which is placed the stumbled part(26) as above-mentioned, is formed at the both of inclined section(12) of center part(11) as above-mentioned,

And, projected elastic stopper(29) by supported of springs on the inner wall of groove(28), and this elastic stopper(29) could be consisted with elastic materials.

At this time, elastic stopper(29) is formed lengthy on the inner wall of groove(28), and formed a number of prevent block of secession(28a) at the entrance side of groove(28) as above-mentioned, which is prevent the secession of stumbling part(27) from the groove(28).

One hand, second hinge(24) is formed the inclined cross-section of a first extension(24) and the part of second extension part(23), and that is conjoined closely to each cross section and its could be consisted with first hinge(22) as well.

Therefore, it has a advantage that stumbling block(26) is blocked to the stopper(29) of groove(28) in several times by first extension part(21) or second extension part(23) in according to move of second extension part(23) and it's move and adjust in a different in a different angle for center part(11) on first extension part(21) and second extension part(23), and second extension part(23) is for first extension part(21).

In this time, although exampled the movable of both of first hinge(22) and second hinge(24), in the accordance of circumstance, it can be movable either one.

On the other hand, in this example, even thought exampled the formed of stumbling part(27) to the around part of stumbling block(26) as above-mentioned, in accordance of circumstance, but it can be formed stumbling part(27) to the whole around of stumbling block(26), and stumbling part(27) can be formed variously such as available to hang of elastic stopper(29).

And this example, however, exampled furnished the stumbled part(26) to one side of inclined section(12) of first hinge(21), and formed groove(28) includes elastic stopper(29) of one side of inclined section(12), as well formed groove(28) to the first extension part(21), and the consist of second hinge(24) which is combined with first extension part(21) and first extension part(21) and extension part(21) or second extension part(23).

Bone conduction speaker part(30) as above-mentioned, equipped to be faced to each second extension part(23) as above-mentioned, and combined between second extension part(32) and hinge axis(25) which is movable in a parallel way to the telocentric of the second extension part(23).

At this time, in this example that hinge axis(25) as above-mentioned, show one side of bone conduction speaker part(30) cover the ball as above-mentioned, but, hinge axis(25) could be formed as a pin connection shape, in accordance with circumstance.

And, bone conduction vibrator is furnished at bone conduction speaker part(30), and this bone conduction vibrator make available to hear the sound without through of eardrum of user by it's vibration.

On this occasion, the extension part(20) as above-mentioned, is consist with plastic material which has elasticity strength of stability that is pressed the bone conduction speaker part(30) to the both ears of skull, and bone conduction vibrator as above-mentioned, vibrate the user's skull.

On the one hand, its noticed already that it can possible to detect the sound in a both way using bone conduction method and using ear drum by use of bone conduction speaker part(30) which is used bone conduction vibrator.

In this invention, as described as FIG. 5, the speaker part(30) make to movable as center of hinge axis(25), speaker part(30) can be conducted to ear direly as occasion demand, as well as it make possible to hear the sound through the ear drum.

Microphone(40) as above-mentioned, is a common thing that convert the external voice signal to electrical signal, and it also convert the other peoples voice or user's voice or occurred voice from external to electrical signal. And, microphone(40) can be built at the extension part(20) or popped up with formative at the extension part(20).

Also, although for this example show the instance of pop up of microphone(40) as above-mentioned, from the extension part(20), according to the circumstance, microphone(40) as above-mentioned, can be furnished with bone conduction speaker part(30) as above-mentioned, and can be consisted at the bone conduction speaker part(30).

FIG. 4, is show of such as spreaded headset's extension part(20), the user wear the headset as this condition. And the 2nd Fig. of Fig. nr 4, show each the 1st and the 2nd extension part(21,23) is flush with center part(11) on the first hinge part's axis.

Also, FIG. 4, is show that move of speaker part(30) at the second extension part(23), and this speaker part(30) is movable to be closed to the second extension part(23), sot that is available to be folded compactly.

And also, the forth figure of FIG. 4, is show that speaker part(30) and the second extension part(23) on it's axis move to the center part(11) closely.

Therefore as described drawing FIG. 4, also it provide headset which is available to keep in the small size case, it make easy to storage or carry because it can be folded compactly.

### Example No. 2

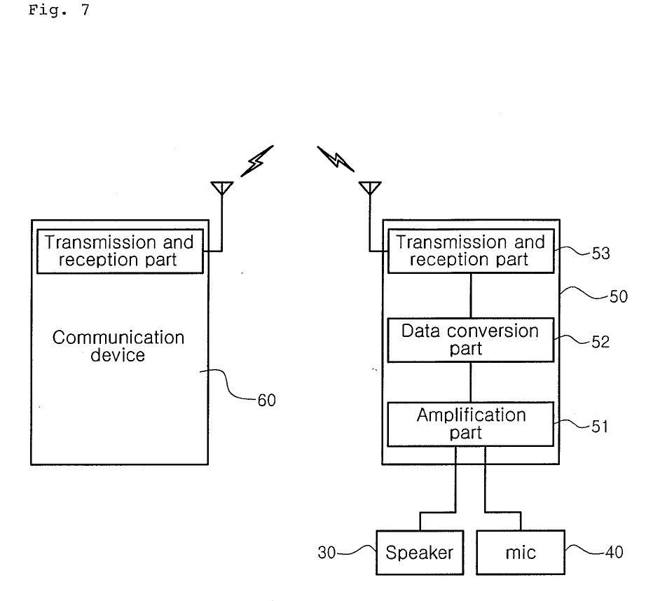

FIG. 3 show that user put Bone Conduction Headset including wireless telecommunication module(50), FIG. 7 show the circuit according to this.

In this case, it show other communication devices, for example cellular phone(60) and wireless headset which is telecommunicated with wireless, this headset is connected mic(40) and speaker(30) and is added short-distance wireless telecommunication module(50) which is able to send wirelessly to other communication devices(60) or receive voice signal wirelessly.

Short-distance wireless telecommunication module(50) as above-mentioned is took in extension part(20) as above-mentioned, the technology of short-distance wireless telecommunication module(50) is able to be used to short-distance wireless telecommunication system for example, bluetooth technology. And short-distance wireless telecommunication module(50) is included with amplification part(51), data conversion part(52) and transmission and reception part(53), is connected as this order, amplification part(51) is connected with microphone(40) and speaker part(30).

Transmission and reception part(53) of short-distance wireless telecommunication module(50) as mention above receive the voice signal which is transmitted from transmission and reception part(53) of other communication devices(60), received digital voice signal is converted into analog signal through data conversion part(52), amplified through amplification part(51) and input in the bone conduction speaker part(30). Also short-distance wireless telecommunication module(50) as above-mentioned transmits wirelessly user's voice, etc. which is received through microphone(40) as above-mentioned. At this case, other communication devices part(60) is not only mobile telecommunication and sound instrument, for example cellular phone or MP3 players, but also fixed telecommunication and sound instrument, for example computers or audios.

Also, extension part(20) as above-mentioned is able to include MP3 module except short-distance wireless telecommunication module(50) so do not have to purchase other communication devices(60), for example MP3 players, except this headset, therefore it is easy to listen to the music without purchasing additional headset for listening to the music through MP3 players.

On the other hand, the side of headset as above-mentioned have selection button(54), using this selection button(54), it can be included to control ON/OFF of short-distance wireless telecommunication module(50). That is, once short-distance wireless telecommunication module(50) is operated, voice signal which is gathered to microphone(40) do not transmit to speaker part(30), voice signal as above-mentioned is transmitted to other communication devices (60) wirelessly, voice signal which is transmitted from other communication devices(60) wirelessly is input to speaker part(30) through short-distance wireless telecommunication module(50). Once short-distance wireless telecommunication module(50) is not operated, voice signal which is transmitted to microphone(40) is amplified in the amplification part(51) and transmit to speaker part(30). Therefore it prevent confusion because speaker part(40) as above-mentioned is connected only one part between other communication devices(60) or microphone(40).

However in this case, it shows short-distance wireless telecommunication module(50) is included in extension part(20), but it would be included in head band part(10) according to circumstances. Therefore there is an advantage the reduction for size and weight of bone conduction speaker(30) as above-mentioned than before. On the other hand, existing headset with bone conduction speaker can listen to the sound through bone conduction speaker with additional wired amplification, this invented bone conduction headset include short-distance wireless telecommunication module(50), therefore it can be perfect wireless bone conduction headset.

On the other hand, inside of extension part(20) as above-mentioned includes elastic material, extension part(20) is formed telescope type in order to be placed in user's both ears with bone conduction speaker part(30), the length of extension part(20) can be controlled by user's body. And headset as above-mentioned uses long-term using battery, for example Lithium-polymer battery, this battery is put in the head band part(10) with charging jack.

The process of listening the sound through invented bone conduction headset, first, user or the other man's voice or sound is transmitted through microphone (40), this sound signal is converted into electrical signal in the microphone(40), amplified in the amplification part(51), transmitted in the bone conduction speaker part(30). At this time, once electrical signal as above-mentioned is converted into vibration signal by bone conduction vibrator and it vibrates user's skull, user can listen to the sound by this vibration. Also user move bone conduction speaker(30) as above-mentioned to ear, user can listen to the sound by vibrating the eardrum.

Also the voice signal by other communication devices(60) is transmitted wirelessly, this signal is transmitted in the transmission and reception part(53), converted into original voice by data conversion part(52). this converted voice signal is amplified by amplification part(51) and transmitted to speaker part(30), voice signal as above-mentioned is converted into vibration signal by bone conduction vibrator and user can listen to the sound of other communication devices(60) by this vibration. And the voice which is collected by microphone(40) is transmitted to other communication devices(60) by short-distance wireless telecommunication module(50), if the other communication devices(60) is cellular phone, user's voice would be transmitted to the other.

### Example No. 3

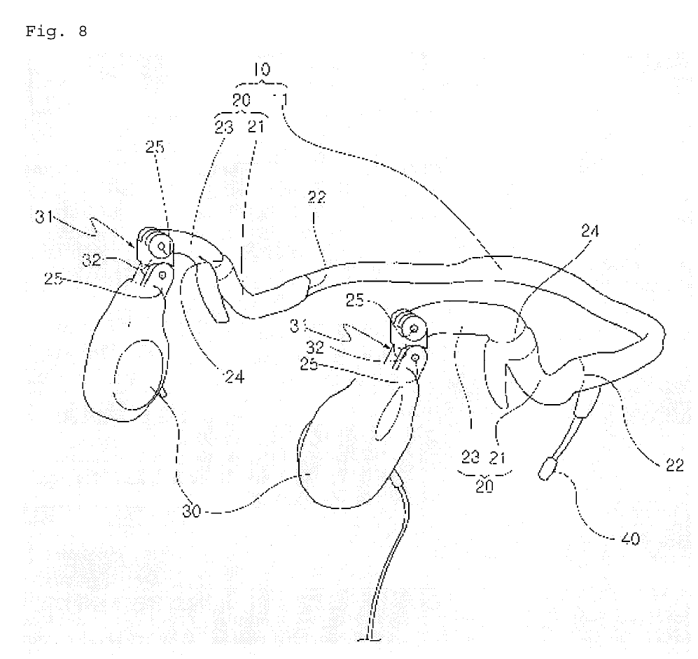

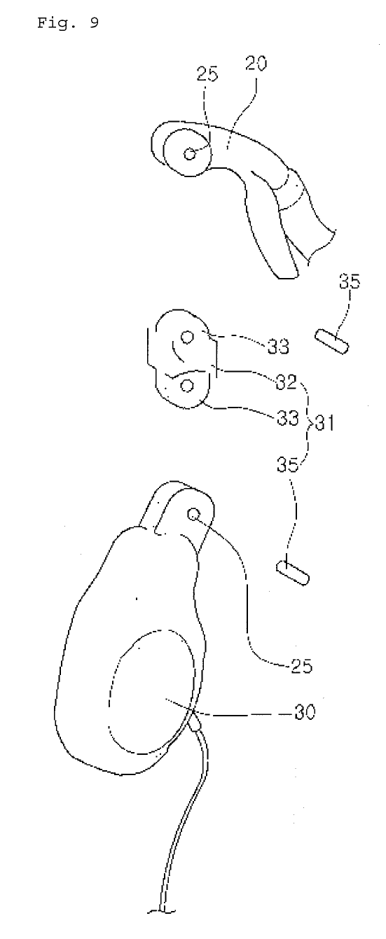

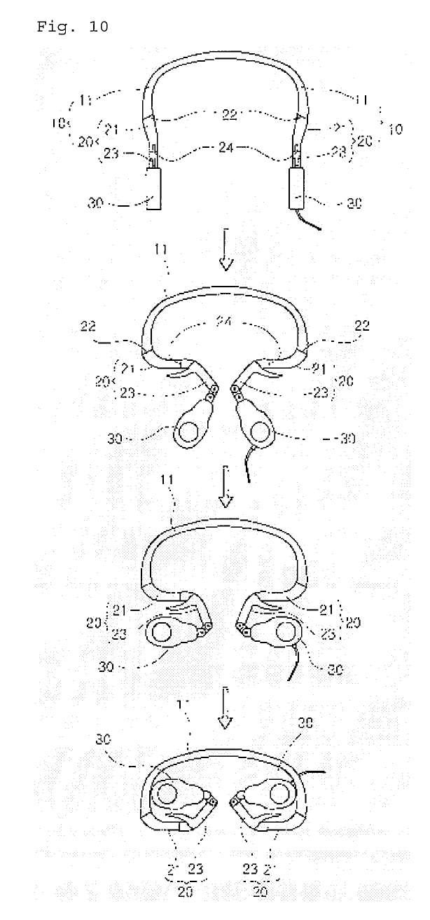

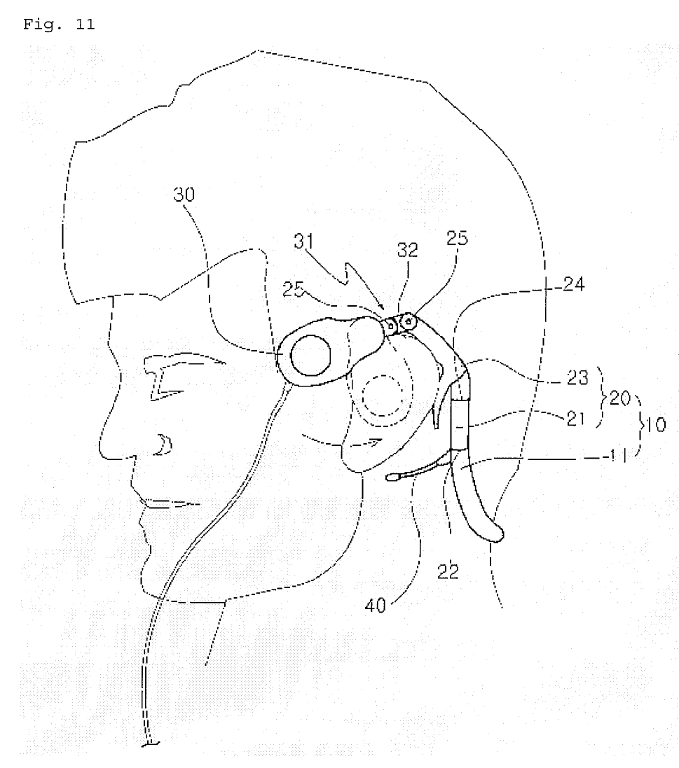

FIG. 8 is plan of the other example by inventing of bone conduction headset, FIG. 9 is disassembly plan of speaker part structure, FIG. 10 is plan for process of folding the headset of FIG. 8, FIG. 11 is using state plan of FIG. 8.

Connection part(31) as above-mentioned is formed to block type, it include connection block(32) which is formed the both side connection projection(33) and connection pins(35) which is connected with hinge axis(25) both extension part(20) and bone conduction speaker part(30) and connection projection(33) of connection block(32). At this time, hinge axis(25) as above-mentioned is formed groove type in the same direction, desirably, as illustrated it is formed open of both side, connection projection(33) as above-mentioned is movable various angle in the hinge axis(25). On the other hand, in this example it shows that the connection method is pin connection type both hinge axis(25) as above-mentioned and connection block(32), but hinge axis(25) could be formed ball type and that could be one side of connection block cover the ball as above-mentioned. Similarly, connection projection(33) of connection block(32) could be formed ball type and be connected. Like this, connection method is various.

And in case of hinge conjunction of hinge axis(25) which is included in the connection block(31) as above-mentioned, extension part(20) as above-mentioned and bone conduction speaker part(30), each conjunction pin(35) is conjoined with hinge in the same direction, connection block(31) is movable to skim user's side skull and ear, only this direction. This is similar to move the chain.

One side of bone conduction speaker(30) as above-mentioned forms the hinge axis(25) with the same of hinge axis(25) of extension part(20). And this hinge axis(25) is conjoined with inserted conjunction projection(33) of connection block(32). By the Connection block(31) as above-mentioned, bone conduction speaker part(30) as above-mentioned is movable on the extension part(20) and it could be placed various angle, there is an advantage of placing in the each ear suitably.

FIG. 10 shows the process of folding the headset, FIG. 11 shows using state according to example as above-mentioned, in comparison with FIG. 4 and FIG. 5, there is additional connection block(31) in the space of hinge axis(25) of the end of second extension part(23) and the top of bone conduction speaker part(30), it is easy to move the bone conduction speaker part(30) so it is fitted suitably in each user's ears and folded more compactly.

This invention as mentioned is not limited or restricted by examples as above-mentioned and attached drawings, various substitution, possibility of transformation, alteration and modification within the limits of technical ideology is obvious to anybody who has general knowledge in the technology belonged this invention.

### INDUSTRIAL APPLICABILITY

This invention could be used with great number of people whose ear is different each one, provides bone conduction headset to be used by not only hearing impaired, but also non-hearing impaired. Also it provide headset which is available to keep in the narrow and small space without worry about damage because it can be folded compactly. Furthermore, it includes wireless telecommunication module, it provides bone conduction headset which is connected wirelessly with cellular phone or many kinds of multimedia instruments, therefore it can be used extensively in many kinds of manufacture in earphone, headphone and hands-free for cellular phone, etc and hearing aids.

1. Bone conduction headset comprising:
head band part(10) which is weared or put in the head consisted of
(a) the center part(11) which includes each first hinge(22) in both side, and (b) first extension part(21) which is conjoined to the first hinge(22) in one side, and (c) second extension part(23) which is conjoined in one side to the second hinge(24) included the other side of the first extension part(21), conjoined in the other side to the hinge axis (25);
a pair of bone conduction speaker part(30) which is included of bone conduction vibrator and is conjoined to hinge axis(25) of second extension part(23) as above-mentioned movably;
microphone(40) which is included to widen bone conduction speaker part(30) to head band part(10) as above-mentioned or is formed with bone conduction speaker part(30);
and the first hinge(22) is comprised by coupling inclined section(12a) which is inclined in upward direction from the outside to inside on both side of center part(1 1) and inclined section(12) on one part of the first extension part(21) which is surface-connected with the inclined section(12a), and the second hinge(24) is comprised by coupling the other part of the first extension part(21) and the one part of the second extension part(23).

2. Bone conduction headset according to claim 1,
wherein the first hinge(22) or second hinge(24) include means for controlling the rotating angle of the first extension part(21) or the second extension part(23), and the controlling means is placed on the one side of second hinge(24) or one side of inclined section(12) of first hinge(22) as above-mentioned, the controlling means include stumbled part(26) which is formed with several stumbling part(27) on the surroundings, and the groove(28) which is placed on another side of inclined section(12a) of first hinge(22) or another side of second hinge(24), inserted by stumbled part(26), the groove(28) includes elastic stopper(29) which is caught of stumbling part(27) as above-mentioned by moving first extension part(21) or second extension part(23).

3. Bone conduction headset according to claim 1, short-distance wireless telecommunication module(50) which is transmitted and received with other communication devices and amplification mean are placed on the first extension part(21) or second extension part(23) or head band part(10), connected with speaker part(30) and microphone(40).

4. Bone conduction headset according to claim 1, wherein the hinge axis(25) of each bone conduction speaker part(30) and hinge axis(25) of one side of second extension part(23), a pair of connection block(31) is conjoined between them, it is movable from second extension part(23) to bone conduction speaker part(30) with several articulations, it is easy to move the bone conduction speaker part more freely.

5. Bone conduction headset according to claim 2,
short-distance wireless telecommunication module(50) which is transmitted and received with other communication devices and amplification mean are placed on the first extension part(21) or second extension part(23) or head band part(10), connected with speaker part(30) and microphone(40).

6. Bone conduction headset according to claim 2,
wherein the hinge axis(25) of each bone conduction speaker part(30) and hinge axis(25) of one side of second extension part(23), a pair of connection block(31) is conjoined between them, it is movable from second extension part(23) to bone conduction speaker part(30) with several articulations, it is easy to move the bone conduction speaker part more freely.
